(19) United States
(12) Patent Application Publication
(10) Pub. No.: US 2011/0231239 A1
(43) Pub. Date: Sep. 22, 2011

(54) METHOD AND SYSTEM FOR ATTRIBUTING AN ONLINE CONVERSION TO MULTIPLE INFLUENCERS

(76) Inventors: Sharon Burt, North Kingstown, RI (US); Carl A. Dunham, Wakefield, RI (US); Edward M. Ives, Exeter, RI (US); Michael H. Jarvinen, Los Angeles, CA (US)

(21) Appl. No.: 12/724,560

(22) Filed: Mar. 16, 2010

(51) Int. Cl. G06Q 30/00

(52) U.S. Cl. 705/14.41

(57) ABSTRACT

A method is provided for identifying and crediting interactions leading to a conversion, comprising acts of for each of at least one defined time interval, defining a recency factor used to scale a credit amount given to an influencing event occurring during the defined time interval; identifying at least one influencing event that influenced a conversion event; for each of the at least one influencing events, identifying a defined time interval in which the influencing event occurred and accessing the recency factor for that defined time interval; and apportioning the credit amount given to the conversion event among the at least one influencing event according to the recency factor for each influencing event.

### BACKGROUND

1. Field of the Invention

The present invention is directed to online advertising.

2. Discussion of Related Art

Online advertising comes in many forms, including banner ads, “sponsored” keyword search results, and targeted emails. Marketers typically use online advertising in conjunction with more traditional forms of advertising, including print, radio, and television advertising, as well as non-advertising contacts such as telephone contact initiated by the consumer or the marketer.

Marketers seeking to evaluate the effectiveness of their advertising efforts have developed several metrics to measure how frequently an advertisement leads to further interest and ultimately a conversion. A conversion is a desired action, such as purchasing a product or providing an email address to receive more information, taken by a consumer in response to advertising or other contact with the marketer. By assigning a value to conversions (for example, the profit realized on a sale) marketers can compare the value of the conversions associated with a particular advertisement to the price paid to run that advertisement to determine if the advertisement is profitable. This information is valuable in formulating bids for online advertising to appear on search engines such as those offered by GOGGLE, Inc. (Mountain View, Calif.) and the Microsoft Corporation (Redmond, Wash.), among others.

### SUMMARY

Aspects of the present invention relate to apportioning credit for an online conversion among multiple influencing events. Most conversion metrics presently known in the art are capable of tracking the advertisement, email, or other contact with the marketer that directly led to the conversion. However, this approach suffers from the fact that many conversions are a result of one or more interactions prior to the conversion. In reality, a conversion can often be envisioned not as a singular event, but rather as a funneling process in which several increasingly-specific interactions play a role. Earlier interactions may tend to be more broadly focused as the user begins to research a topic, whereas later interactions may become more focused as the consumer becomes more knowledgeable about the subject matter and begins to plan for the final conversion event.

For example, a consumer may be interested in purchasing a widget without knowing what brand to purchase. A search engine search on the keyword “widget” may return a sponsored search result in the form of an advertisement for Acme brand widgets. After suspending the purchasing process for a few weeks, the consumer may view a television advertisement for Acme brand widgets, remember the advertisement for Acme brand widgets she previously saw, and call a telephone number appearing in the television advertisement with a question about the product. Days later, having decided to purchase an Acme brand widget, the consumer may perform a search engine search for “acme widgets,” follow a sponsored search result, and complete a purchase for Acme brand widgets.

Whereas most conversion metrics defined in the art would recognize the final search engine search for “acme widgets” as the sole advertisement driving the conversion (i.e., the sale), this search was performed after the consumer had already decided to purchase Acme brand widgets. However, the relative roles of the original search engine search, the television advertising, and the telephone call, are all beyond the scope of the traditional conversion metric. This oversight can prove costly in that, under the traditional “last click” conversion model, a marketer would give credit for the entire conversion to this last, post-decision search and overpay in the future to place advertisements in connection with such so-called branded searches, while ignoring the role played by the earlier influences that actually shaped the decision.

Though some references may disclose methods for apportioning credit among several influencing interactions, these references either give no consideration to the recency of the interaction, or else apply a “one-size-fits-all” linear function wherein, for example, an influencing event that is twice as old as a more recent event is given half of the credit of the more recent event. There is presently no method or system for allowing a user to define recency factors for custom time intervals leading up to the conversion event. Such a method or system would be useful for allowing marketers to define time intervals based on their real-world knowledge and experience, such that all influencing events occurring within a time interval would be weighted the same for recency purposes. For example, a user may decide, based on experience, that an influencing event occurring two weeks before a conversion event should be weighed the same as an influencing event occurring one week before the conversion event (despite the fact that the former is twice as distant in time as the latter) whereas an influencing event occurring three weeks before the conversions event should be given no credit at all for the conversion. Furthermore, the user may wish to define different time intervals for different types of interaction events. For example, the user may determine that the weight given to a television advertisement being viewed by a consumer should drop off rapidly with time, whereas a telephone conversation with a sales representative will play an important role in the eventual conversion no matter how distant in time it is. According to various aspects consistent with principles of the present invention, methods and systems are provided for identifying and crediting interactions leading to a conversion.

According to one aspect of the present invention, a system and method are provided for apportioning credit for a conversion event among several influencing events that influenced the conversion event. The influencing events may be online (e.g., web browsing or email) or offline (e.g., telephone interactions, billboards, print ads, etc.) and may be matched to the marketing activity driving the conversion event according to the systems and techniques described herein. The credit may be apportioned at least partially according to user-definable recency factors. A system operator may be able, through use of an operator interface, to define the length and date coverage of one or more time periods preceding the conversion event, and define relative weights to be given to the influencing events occurring during each time period. In this way, the system operator can fine-tune credit given to events in each period, and, for example, may define a dropoff in the credit given to an influencing event the more distant the influencing event is in time from the conversion event. The rate of drop-off can be defined by the system operator, and the granularity with which these time periods are defined (i.e., whether a time period covers, for example, 1 day or 1 week) can also be set by the user.

According to one aspect of the present invention, a method for identifying and crediting interactions leading to a conversion event is provided. The method comprises acts of, for each of at least one defined time interval, defining a recency factor used to scale a credit amount given to an influencing event occurring during the defined time interval; identifying at least one influencing event that influenced a conversion event; for each influencing event, identifying a defined time interval in which the influencing event occurred and accessing the recency factor for that defined time interval; and apportioning the credit amount for the conversion event to the at least one influencing event according to the recency factor for each influencing event.

In accordance with one embodiment, the method further comprises the act of identifying the conversion event, wherein the act of identifying comprises processing information relating to the at least one influencing event.

In accordance with another embodiment, the method further comprises the act of defining criteria for the at least one influencing event that influences a conversion event.

In accordance with yet another embodiment, the method further comprises the acts of assigning a first recency factor to a first influencing event; and assigning a second recency factor to a second influencing event occurring after the first influencing event; wherein the first recency factor is less than the second recency factor.

In accordance with still another embodiment, the act of identifying a defined time interval in which the influencing event occurred includes for each of the at least one influencing event, calculating an elapsed time between the influencing event and the conversion event; accessing an interval start time and an interval end time associated with the defined time interval; and for each of the at least one influencing event, evaluating whether the elapsed time is less than the interval start time and greater than the interval end time.

In accordance with another embodiment, the act of apportioning credit for the conversion event among the at least one influencing event according to the recency factor for the influencing event includes multiplying a conversion credit by the recency factor.

In accordance with yet another embodiment, the method further comprises the act of, for each of the at least one defined time interval, defining a debit factor used to modify the credit given to an influencing event occurring during the defined time interval.

In accordance with yet another embodiment, the credit apportioned to the at least one influencing event according to the recency factor is debited from the credit apportioned to the influencing event occurring closest in time to the conversion event according to the debit factor.

In accordance with yet another embodiment, the method further comprises the act of generating at least one bid recommendation for at least one advertising element associated with the at least one influencing event, wherein the bid recommendation is based on the credit apportioned to the at least one influencing event according to the recency factor associated with the influencing event.

In accordance with another embodiment, the method further comprises the act of providing information about at least one advertising element to a bid recommendation system, the information including an identifier of at least one influencing event related to the at least one advertising element, the information further including the credit apportioned to the at least one influencing event according to the recency factor associated with the influencing event.

In accordance with still another embodiment, the influencing event includes displaying an advertisement to a user of the world wide web.

In accordance with a further embodiment, the advertisement is displayed in response to the user performing a search on a search engine web page. In accordance with a still further embodiment, the influencing event further includes the user interacting with a hypertext link on an advertisement on the world wide web.

In accordance with another embodiment, the influencing event includes a user receiving an email. In accordance with a further embodiment, the influencing event further includes a user interacting with a hypertext link in an email.

In accordance with yet another embodiment, the influencing event includes a user dialing a telephone number selected from a plurality of telephone numbers, the selection being made responsive to an online search performed by the user.

In still another embodiment, the influencing event includes a user dialing a telephone number displayed on a non-interactive medium.

In yet another embodiment, the method further comprises the acts of, for each of the at least one influencing events, accessing a second factor based on the nature of the influencing event; associating the second factor with the influencing event; and apportioning credit for the conversion event among the at least one influencing event according to the second factor for the influencing event. According to a further embodiment, the second factor is an event type factor correlated to an attribute of the influencing event. According to a still further embodiment, a first event type factor is applied to a first type of influencing event, and wherein a second event type factor is applied to a second type of influencing event. According to yet a further embodiment, the method further comprises an act of for each of the at least one influencing events, multiplying the event type factor and the recency factor by the conversion credit to generate an adjusted conversion credit. According to a further embodiment, the second factor is a user attribute factor associated with at least one attribute of a user associated with the influencing event. According to a still further embodiment, the user attribute factor is associated with the age of the user. According to a further embodiment, the second factor is a chronological factor, wherein the chronological factor is determined by a count of influencing events that occurred prior to the influencing event.

According to another embodiment, the method further comprises the act of receiving user input through a user interface, wherein the act of defining criteria for at least one influencing event is performed in accordance with the user input.

According to another embodiment, the method further comprises the acts of receiving user input through a user interface; and setting the recency factor in accordance with the user input.

According to yet another embodiment, the method further comprises the acts of receiving user input through a user interface; and defining the defined time intervals in accordance with the user input.

According to another aspect of the present invention, a computer-readable medium comprising computer-executable instructions that, when executed on a processor of a server, perform a method for identifying and crediting interactions leading to a desired action. The method comprises acts of, for each of at least one defined time interval, defining a recency factor used to scale a credit amount given to an influencing event occurring during the defined time interval; identifying at least one influencing event that influenced a conversion event; for each influencing event, identifying a defined time interval in which the influencing event occurred and accessing the recency factor for that defined time interval; and apportioning the credit amount for the conversion event to the at least one influencing event according to the recency factor for each influencing event.

According to one embodiment, the method further comprise acts of assigning a first recency factor to a first influencing event; and assigning a second recency factor to a second influencing event occurring after the first influencing event; wherein the first recency factor is less than the second recency factor.

According to another embodiment, the method further comprises the act of, for each of the at least one defined time interval, defining a debit factor used to modify the credit given to an influencing event occurring during the defined time interval.

According to yet another embodiment, the influencing event includes a user dialing a telephone number selected from a plurality of telephone numbers, the selection being made responsive to an online search performed by the user.

According to still another embodiment, the the influencing event includes a user dialing a telephone number displayed on a non-interactive medium.

According to another embodiment, the method further comprises the the act of, for each of the at least one influencing events, accessing a second factor based on the nature of the influencing event; associating the second factor with the influencing event; and apportioning credit for the conversion event among the at least one influencing event according to the second factor for the influencing event. According to a further embodiment, the second factor is an event type factor correlated to an attribute of the influencing event. According to a still further embodiment, the method further comprises an act of, for each of the at least one influencing events, multiplying the event type factor and the recency factor by the conversion credit to generate an adjusted conversion credit.

According to yet another embodiment, the second factor is a user attribute factor associated with at least one attribute of a user associated with the influencing event. According to another embodiment, the second factor is a chronological factor, and wherein the chronological factor is determined by a count of influencing events that occurred prior to the influencing event.

According to still another aspect of the present invention, a system is provided. The system comprises an influencing event database configured to store information about at least one influencing event that influenced an online conversion; and an apportioning engine configured to identify a defined time interval during which at least one influencing event occurred, and apportion credit for the online conversion among the at least one influencing event according to a scaling factor associated with the defined time interval.

According to one embodiment, the system further comprises a criteria database configured to store influencing event criteria.

According to another embodiment, the system further comprises a conversion event database configured to store information about at least one conversion event.

According to yet another embodiment, the system further comprises an identifying engine configured to identify an influencing event with reference to the influencing event criteria.

According to still another embodiment, the system further comprises a factor database configured to store at least one scaling factor associated with at least one defined time intervals.

According to yet another embodiment, the online conversion is a sale.

According to another embodiment, the system further comprises at least one interface configured to receive user input through a user interface, the user input including at least one scaling factor and at least one defined time interval.

According to another embodiment, the system further comprises at least one reporting interface configured to display information about at least one influencing event and at least one defined time interval.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example computer system upon which various aspects of the present invention may be implemented;

FIG. 2A shows an example system for crediting multiple influencers for an online conversion in the context of a distributed system in accordance with one embodiment of the invention;

FIG. 2B depicts an example physical and logical diagram of the system of FIG. 2A in more detail;

FIG. 3 shows a controller device interface in accordance with embodiments of the present invention;

FIG. 4 illustrates an example process for crediting multiple influencers for an online conversion in accordance with one embodiment of the invention;

FIG. 5 depicts an exemplary data format suitable for use with embodiments of the present invention; and

FIG. 6 shows an exemplary reporting interface in accordance with embodiments of the present invention.

### DETAILED DESCRIPTION

The aspects disclosed herein, which are consistent with principles of the present invention, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to crediting multiple influencers for an online conversion. However, such a system may also perform other functions. Moreover, the systems described herein may be configured to include or exclude any of the functions discussed herein. Thus, the invention is not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

According to various embodiments of the present invention, a system and method are provided for apportioning credit for an online conversion event among one or more influencing events that influenced the eventual conversion event. One or more defined time intervals may be defined by the user to correspond to a particular interval of time preceding the conversion event. Also, a recency factor may be defined for each of the defined time intervals that is used to determine how much credit should be given to each influencing event occurring during that defined time interval. In this manner, it can be determined for each influencing event which of the defined time intervals covers the interval of time during which the influencing event occurred. The recency factor corresponding to each defined time interval can then be applied to each influencing event occurring during the defined time interval, such that the credit for the conversion event can be apportioned among the influencing events based on the recency model defined by the defined time interval and recency factor. In this manner, more credit may be given to more recent influencing events if so desired, with the drop-off in credit for older influencing events being configurable by the user or the system.

According to various embodiments, a debit factor may also be associated with each defined time interval, so that the amount of credit initially assigned to an influencing event occurring during that defined time interval can be reduced, for example, in order to compensate for credit that is assigned to other influencing events. This may allow for further redistribution of the credit that would typically go to the single “last click” influencing event under traditional attribution models. The debit factor associated with the defined time interval may be independent of the recency factor associated with other defined time intervals, with the effect that the total amount of credit given to all influencing events for a particular conversion event may be more or less than the amount of credit that would otherwise have been given to a single influencing event. According to other embodiments, the debit factor may be applied against events or advertising objects unrelated to the conversion event. The debit factor may be applied according to one or more criteria. For example, when credit is assigned to an influencing event associated with a particular advertising element (for example, a particular keyword), the debit factor may be applied against some or all of the other advertising elements (for example, keywords not associated with the influencing event). In this way, advertising elements can be prioritized according to performance metrics, for example, by lowering bid recommendations for advertising elements that perform poorly relative to other advertising elements.

One or more of these features may be implemented on one or more computer systems coupled by a network (e.g., the Internet). Example systems upon which various aspects are implemented are discussed in more detail below.

### Computer System

Various aspects and functions described herein in accord with the present invention may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system elements and components using a variety of hardware and software configurations, and the invention is not limited to any particular distributed architecture, network, or communication protocol.

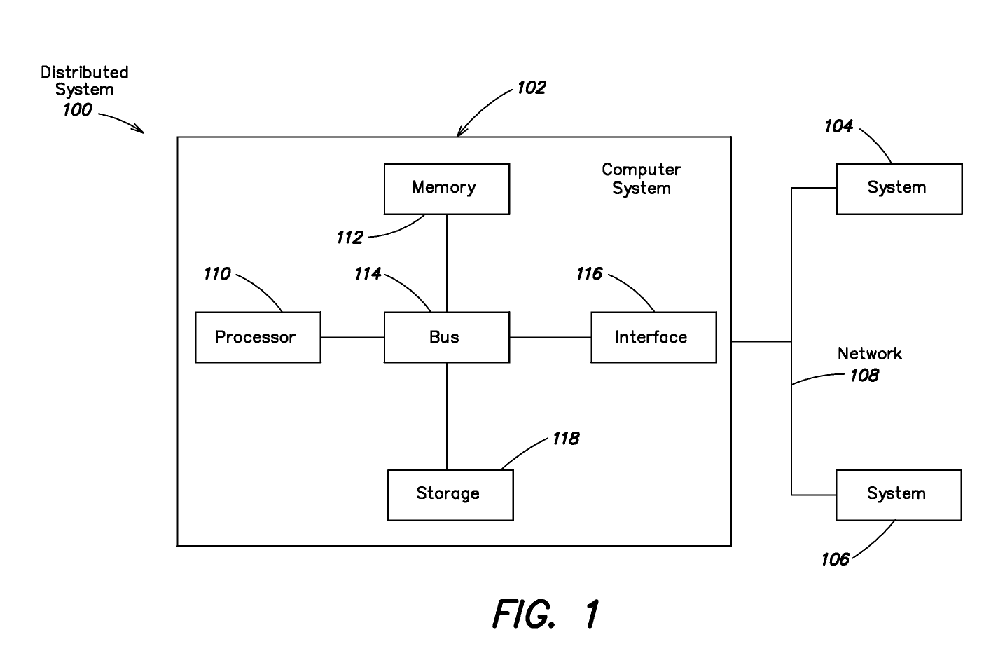

FIG. 1 shows a block diagram of a distributed computer system 100, in which various aspects and functions in accord with the present invention may be practiced. The distributed computer system 100 may include one more computer systems. For example, as illustrated, the distributed computer system 100 includes three computer systems 102, 104 and 106. As shown, the computer systems 102, 104 and 106 are interconnected by, and may exchange data through, a communication network 108. The network 108 may include any communication network through which computer systems may exchange data. To exchange data via the network 108, the computer systems 102, 104 and 106 and the network 108 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA BOP, RMI, DCOM and Web Services. To ensure data transfer is secure, the computer systems 102, 104 and 106 may transmit data via the network 108 using a variety of security measures including TSL, SSL or VPN, among other security techniques. While the distributed computer system 100 illustrates three networked computer systems, the distributed computer system 100 may include any number of computer systems, networked using any medium and communication protocol.

Various aspects and functions in accord with the present invention may be implemented as specialized hardware or software executing in one or more computer systems including the computer system 102 shown in FIG. 1. As depicted, the computer system 102 includes a processor 110, a memory 112, a bus 114, an interface 116 and a storage system 118. The processor 110, which may include one or more microprocessors or other types of controllers, can perform a series of instructions that manipulate data. The processor 110 may be a well-known, commercially available processor such as an Intel Pentium, Intel Atom, Motorola PowerPC, SGI MIPS, Sun UltraSPARC, or Hewlett-Packard PA-RISC processor, or may be any other type of processor or controller as many other processors and controllers are available. As shown, the processor 110 is connected to other system elements, including a memory 112, by the bus 114.

The memory 112 may be used for storing programs and data during operation of the computer system 102. Thus, the memory 112 may be a relatively high performance, volatile, random access memory such as a dynamic random access memory (DRAM) or static memory (SRAM). However, the memory 112 may include any device for storing data, such as a disk drive or other non-volatile storage device. Various embodiments in accord with the present invention can organize the memory 112 into particularized and, in some cases, unique structures to perform the aspects and functions disclosed herein.

Components of the computer system 102 may be coupled by an interconnection element such as the bus 114. The bus 114 may include one or more physical busses (for example, busses between components that are integrated within a same machine), and may include any communication coupling between system elements including specialized or standard computing bus technologies such as IDE, SCSI, PCI and InfiniB and. Thus, the bus 114 enables communications (for example, data and instructions) to be exchanged between system components of the computer system 102.

The computer system 102 also includes one or more interface devices 116 such as input devices, output devices and combination input/output devices. The interface devices 116 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 116 allow the computer system 102 to exchange information and communicate with external entities, such as users and other systems.

The storage system 118 may include a computer-readable and -writeable nonvolatile storage medium in which instructions are stored that define a program to be executed by the processor. The storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk or flash memory, among others. In operation, the processor 110 or some other controller may cause data to be read from the nonvolatile recording medium into another memory, such as the memory 112, that allows for faster access to the information by the processor 110 than does the storage medium included in the storage system 118. The memory may be located in the storage system 118 or in the memory 112. The processor 110 may manipulate the data within the memory 112, and then copy the data to the medium associated with the storage system 118 after processing is completed. A variety of components may manage data movement between the medium and the memory 112, and the invention is not limited thereto.

Further, the invention is not limited to a particular memory system or storage system. Although the computer system 102 is shown by way of example as one type of computer system upon which various aspects and functions in accord with the present invention may be practiced, aspects of the invention are not limited to being implemented on the computer system, shown in FIG. 1. Various aspects and functions in accord with the present invention may be practiced on one or more computers having a different architectures or components than that shown in FIG. 1. For instance, the computer system 102 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 102 may include an operating system that manages at least a portion of the hardware elements included in computer system 102. A processor or controller, such as processor 110, may execute an operating system which may be, among others, a Windows-based operating system (for example, Windows NT, Windows 2000/ME, Windows XP, Windows 7, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various aspects and functions in accord with the present invention may be implemented in a non-programmed environment (for example, documents created in HTML, XML or other format that, when viewed in a window of a browser program, render aspects of a graphical-user interface or perform other functions). Further, various embodiments in accord with the present invention may be implemented as programmed or non-programmed elements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing commercial product, such as, for example, Database Management Systems such as SQL Server available from Microsoft of Seattle, Wash.; Oracle Database from Oracle of Redwood Shores, Calif.; and MySQL from Sun Microsystems of Santa Clara, Calif.; or integration software such as WebSphere middleware from IBM of Armonk, N.Y. However, a computer system running, for example, SQL Server may be able to support both aspects in accord with the present invention and databases for sundry applications not within the scope of the invention.

### Example System Architecture

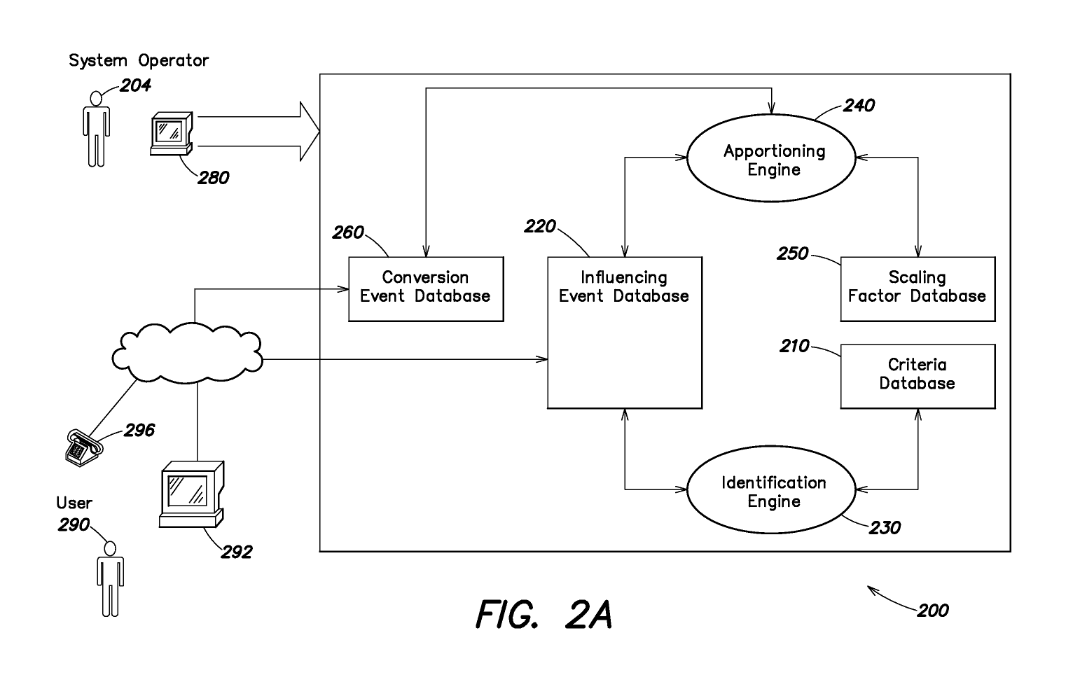

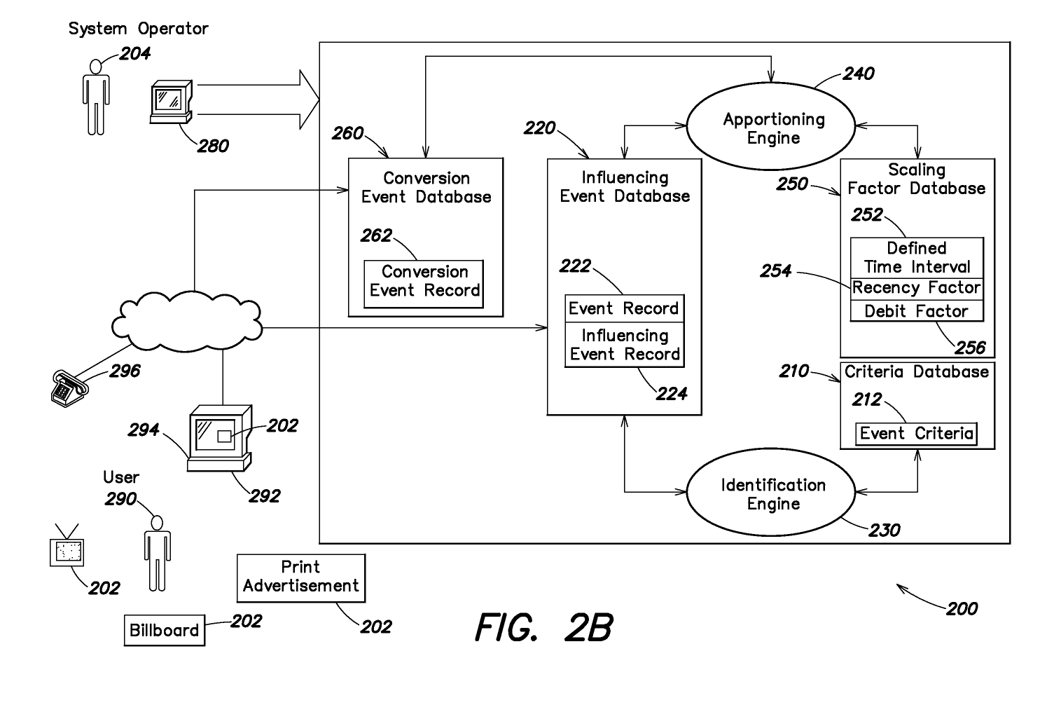

FIGS. 2A and 2B show a block diagram of a system 200 for identifying and crediting interactions leading to a conversion event according to an embodiment of the present invention. The system 200 includes a criteria database 210, an influencing event database 220, an event identification engine 230, an apportioning engine 240, a scaling factor database 250, and a conversion event database 260.

The criteria database 210 is configured to store several event criteria 212 that define the characteristics of an influencing event. With reference to the event criteria, the event identification engine 230 can identify and flag influencing events from among a set of online activity. An event record 222 contains information about an influencing event and can be stored in the influencing events database 220. After a conversion event occurs (e.g, a sale or signup), the conversion event database 260 may be configured to store a conversion event record 262 containing information about the conversion event, for example, when the event occurred.

According to one embodiment, the event identification engine 230 is configured to identify which influencing events represented by event records 222 are associated with the conversion event stored as conversion event record 262. Those event records 222 can then be flagged as special types of event records 222 referred to as influencing event records 224. Apportioning engine 240 may include functionality to calculate the amount of elapsed time between each influencing event and its associated conversion event, and determine with reference to the scaling factor database 250 in which defined time interval 252 the influencing event occurred. Apportioning engine 240 can then access the correct recency factor 254 stored in the scaling factor database 250 and apply the factor to the event record 222 for the influencing event so that the influencing event is properly credited for the conversion based on its recency. In some embodiments, other scaling factors may also be accessed in the factor database 250 and applied accordingly. In some embodiments, a user interface 280 may be provided to allow a user 290 to define the defined time intervals 252, as well as assign and adjust recency factors 254 or other factors as is desired.

The use of the word “user” herein may refer to an individual using the system 200. However, references to the user 290 should not be so limiting but should be construed to also refer to the computing environment used by the user 290. For example, in some embodiments it may not be possible to identify the user 290 by name or other personally-identifying information. In these embodiments, the user 290 may actually be tracked by some aspect of the computer system he/she is using, for example, IP address, login ID, browser-related data, tracking cookie, or other information.

A “conversion event” as used herein is an act performed by a consumer or other user, with the act being desirable to a marketer. For example, to a marketer selling goods, the relevant conversion event may be a sale of goods. To a marketer providing information or direct communication, the conversion event may be a user enrolling to be a user of a particular website, or signing up to receive future communications from the marketer. An “influencing event” as used herein is an interaction between a marketer and a consumer that precedes and influences the conversion event. An influencing event may occur seconds, minutes, hours, days, weeks, months, or years before the conversion event with which it is ultimately associated. The “last influencing event” or “final influencing event,” as it may be referred to herein, is the so-called “last click” that occurs closest in time to the conversion event and directly leads to the conversion event. For example, the last influencing event may include displaying a sponsored search result to a user, who clicks on the sponsored search result, is redirected to a marketer's website, and purchases a product, the purchase being a conversion event.

The criteria database 210, influencing event database 220, event identification engine 230, apportioning engine 240, scaling factor database 250, conversion event database 260, and interface 280 may be interconnected in a variety of ways and able to interact as described below. These sundry computer systems shown in FIGS. 2A and 2B each may include one or more computer subsystems. As discussed in regard to FIG. 1, such computer systems may have one or more processors or controllers, memory, and interface devices. In certain embodiments, one or more of the elements depicted as being distinct elements in FIGS. 2A and 2B may be implemented on the same system. For example, one or more of the criteria database 210, influencing event database 220, scaling factor database 250, and conversion event database 260 may be implemented on the same system, and may be implemented as different tables within one database. Similarly, the event identification engine 230, the apportioning engine 240, and the interface 280 may be different functions implemented in a single application, or as different executable programs running on the same processor. The particular configuration of system 200 depicted in FIGS. 2A and 2B is used for illustration purposes and it should be appreciated that embodiments of the invention may be practiced in other contexts, as the invention is not limited to a specific number of users or to a specific number or type of systems.

Information may flow between the elements, components, and subsystems of the system 200 using any technique. Such techniques include, for example, passing the information over the network via TCP/IP, passing the information between modules in memory, and passing the information by writing to a file, database, or some other non-volatile storage device. In addition, pointers or other references to information may be transmitted and received in place of, or in addition to, copies of the information. Conversely, the information may be exchanged in place of, or in addition to, copies of the information. Other techniques and protocols for communicating information may be used without departing from the scope of the embodiments described herein.

Referring to FIG. 2B, in several embodiments, the criteria database 210 stores event criteria 212, which define the types of interaction between a consumer and a marketer for which the influence attributed to that interaction should be calculated. The data comprising the event criteria 212 may include an identifier signifying the type or location of the advertisement or other promotional material. The event criteria 212 may also include information about the nature of the interaction itself, for example, that a consumer clicked on the banner advertisement or, alternately, an “impression” in which the banner advertisement was displayed to the consumer.

In several embodiments, when an interaction meeting the event criteria 212 is detected, it is recorded as an event record 222 in the influencing event database 220. After a conversion event is detected, the influencing event database 220 is examined and all event records 222 for events identified as influencing the conversion event are flagged as influencing event records 224. Influencing event records 224 are a special type of event record 222, and may be identical in structure to event records 222 except that they may be flagged by setting a variable or otherwise indicating that they correspond to influencing events. As such, references made herein to event records 222 should be construed to include both event records 222 and influencing event records 224.

In some embodiments, an event record 222 may initially include the time and date the event occurred. In some embodiments, information such the day of the week or weekday/weekend status may also be stored or derived. The type of advertising object 202 and the nature of the interaction between the user 290 and the advertising object 202 is also stored in several embodiments. For example, the event record 222 may indicate that the advertising object 202 is a banner advertisement, and the interaction is a click by the user 290 on the banner advertisement. As another example, the interaction may be an impression of a banner advertisement, i.e., the banner advertisement is displayed to the user 290. Additional information about the event may be stored in event record 222. For example, the URL of the advertisement or the page where it is hosted, a text description of the website, or other location-identifying information about the media and/or interaction, may be stored in the event record 222.

Referring still to FIG. 2B, in several embodiments the influencing database 220 may be configured to store a credit value and a debit value for each event record 222. After an influencing event record 224 is flagged, it may be credited with influencing the conversion event by having a credit value assigned to the influencing event record 224 according to one or more factors. In some embodiments, it may further be desirable to assign a debit value to the influencing event record 224 for the “final influencing event”, i.e., the one that that most directly led to the conversion. This debit value may definable by the user 290, and may be equal in magnitude to that credit value, or may be of a different magnitude. In this way, some or all of the credit assigned to the final influencing event can be redistributed to the earlier influencing events. This may be desired where the total amount of credit given for all influencing events should not exceed the credit that would be given to the only influencing event under the traditional “last click” model. In other embodiments, each influencing event record 224 may be assigned credit based on a recency factor 254 or other factors without debiting any credit from the influencing event record 224 for the final influencing event. In some embodiments, only a portion of the credit may be debited. In several embodiments, the total amount of credit given for all influencing events may exceed that which would be given under the traditional “last click” model.

In order to correlate event records 222 with a conversion event, it may be useful to identify influencing events associated with the user 290 who later drives the conversion event. Therefore, in some embodiments, information identifying the user 290 may be stored with each event record 222. For example, in some embodiments, the Internet Protocol (IP) address of the user's computer may be logged and saved. In other embodiments, tracking cookies 294 uniquely identifying the user 290 may be stored on the computer 292 of the user 290 by browser software or other executable software. Such a tracking cookie 294 could be generated and stored during the first interaction between the user 290 and an advertising object 202 associated with a particular marketer, and the tracking cookie 294 could be accessed during each subsequent interaction between the user 290 and the marketer.

In some embodiments, “offline interactions” that arise as a result of an earlier online interaction but take place through a medium other than a computer may also be tracked. In these embodiments, the user 290 may be provided a custom telephone number 296 to call. This custom telephone number 296 may be selected from a pool of available telephone numbers, such that only the user 290 is provided the custom telephone number 296 at a given time. When the system 200 detects that a call to the custom telephone number 296 has been placed, it can be determined that the user 290 is the caller, and the interaction can be tracked. After the interaction or at some later date, the custom telephone number 296 can be recycled into the pool of available numbers and reused for a later transaction.

In several embodiments, the system 200 may be configured to track both online interactions and offline interactions of a given user 290. For example, a tracking cookie 294 may be installed on the computer 292 of the user 290 by web browsing software when the user clicks on an advertising object 202. During the same interaction, the advertising object 202 may display a custom telephone number 296 to the user 290, with the custom telephone number 296 previously associated with the advertising object 202 or a keyword search that caused the advertising object 202 to be displayed. The user 290 may call the custom telephone number 296 for an additional interaction, which can be identified as being related to the earlier keyword search. Furthermore, in this way, both the tracking cookie 294 and the custom telephone number can be associated with the user 290, and both the online and offline interactions of the user 290 can be tracked. In other embodiments, a custom URL (uniform resource locater) (not shown) may be provided to the user 290. When the user 290 visits the custom URL, the user 290 can be identified in a manner similar to the way already described.

In still other embodiments, a custom telephone number 296 or a custom URL may be displayed on a print advertisement, billboard, or other offline advertising object 202, where each individual offline advertising object 202 has its own custom telephone number 296 or custom URL. In these embodiments, identification of the particular user 290 may not be possible when the user 290 initially visits the custom URL or dials the custom telephone number 296, but a tracking cookie 294 or other tracking mechanism can be used to track the user 290 from that point forward, and the details of the first interaction of the user 290 can be identified from the nature of the custom URL or custom telephone number 296. For example, if a user 290 sees a billboard with a custom URL on it and visits the website associated with the URL, it can be determined that the user 290 saw the particular billboard, and the system 200 can begin tracking the user 290 with a tracking cookie 294 during the first visit to the custom URL.

In still other embodiments, other types of influencing events may be tracked. For example, the system 200 may be configured to detect an influencing event when the user 290 prints a coupon, voucher, gift certificate, or other document from a mobile device or computer. As another example, the system 200 may be configured to detect an influencing event when the user 290 is detected near a particular location through the use of GPS or other positional technology. As still another example, the system 200 may be configured to detect an influencing event when the user 290 scans a barcode physically affixed to a product in a retail outlet. As yet another example, the system 200 may be configured to detect an influencing event when the user 290 listens to an internet radio station, views a television program over the internet, or otherwise interacts with streaming or downloadable media in general or a specific source or channel of data in particular.

Referring still to FIG. 2B, the influencing event database 220 may be configured to be updated with derived information after the conversion event occurs and the influencing event records 224 are identified. In some embodiments, a unique identifier identifying a single conversion event record 262 may be stored in an influencing event record 224 after the conversion event has occurred to associate the influencing events with the conversion event that they are believed to have influenced. In other embodiments, the amount of time elapsed between the influencing event and the conversion event may be calculated and stored in the corresponding influencing event record 224. In some embodiments, a recency factor 254 based on that elapsed time may also be stored. In still other embodiments, the influencing event record 224 may be configured to accept and store manual notes entered by a system operator 204.

Referring still to FIG. 2B, in several embodiments, a factor database 250 may be provided and configured to store at least one defined time interval 252 and a recency factor 254 corresponding to each defined time interval 252. A defined time interval 252 is a period of time preceding a conversion event and defined by the amount of time by which the defined time interval precedes the conversion event. For example, a defined time interval 252 may be defined to represent the 7 day-long period of time extending from 14 days before the conversion event to 7 days before the conversion event.

Because, according to one embodiment, the defined time interval 252 may be defined in relation to the conversion event, the actual period of time (i.e., the date and time range) that the defined time interval 252 represents may only be determinable after the conversion event occurs. In some embodiments, the defined time interval 252 may be represented by two values, i.e., the start time (14 days, in the above example) and the end time (7 days, in the above example). In these embodiments, an influencing event would be deemed to fall into a defined time interval 252 if the influencing event occurred after the start time but before the end time. In other embodiments, only one time value may be stored for each defined time interval 252. In these embodiments, an influencing event would be deemed to fall into a defined time interval 252 if the influencing event occurred after the single time value stored for that defined time interval 252 without occurring after the single time value stored for any other defined time interval. In any of these embodiments, the time values stored with a defined time interval 252 may be stored in any of the ways known in the art for storing a duration of time. For example, in some embodiments, the time values may be represented by the number of days, hours, minutes, seconds, or combination thereof, by which the defined time interval 252 precedes the conversion event.

A recency factor 254 may be associated with each defined time interval 252 stored in the factor database 250. The recency factor 254 is used as a scaling factor applied to the credit given to each influencing event occurring during the defined time interval 252 corresponding to the recency factor 254. For example, a defined time interval 252 may be assigned a higher recency factor 254 when it is closer to the conversion event than those defined time intervals 252 that are more remote in time. The recency factor 254 may be a scalar quantity and may be defined in any manner suitable for defining scaling factors, for example, as a decimal value less than 1 or as a percentage value. For example, assume a recency factor 254′ of value “0.5” is assigned to a defined time interval 252′. Each influencing event occurring during that defined time interval 252′ is scaled according to that recency factor 254′. In some embodiments, this may involve multiplying the credit assigned to the influencing event by the recency factor 254, in this case having a value of 0.5. In embodiments where an event is simply identified as either an influencing event (credit=1) or not (credit=0), all influencing events occurring during the defined time interval 252′ will be assigned a credit of 0.5, while leaving non-influencing events at a credit of 0.

In some embodiments, a debit factor 256 may be associated with each defined time interval 252 stored in the factor database 250. The debit factor 256 indicates what portion, if any, of the credit initially given by the recency factor 254 to the final influencing event should be apportioned to other influencing events. For example, if an influencing event occurs during a defined time interval 252 that causes it to be assigned a recency factor 254 of 0.2, it may be desirable to debit some, none, or all of that 0.2 credit from the influencing event record 224 of the final influencing event.

As described above, different recency factors 254 may be assigned to different defined time intervals 252. As such, it will be appreciated that it may be preferable to require that any particular amount of time occurring before a conversion event fall into at most one defined time interval 252. In other words, in some preferred embodiments, no two defined time intervals 252 should overlap. However, it will be appreciated that in other embodiments overlap between defined time intervals 252 may be allowed, and in those situations interpolation or other mathematical means to harmonize the various recency factors 254 associated with the overlapping defined time intervals 252 may be employed.

In several embodiments, the factor database 250 may be configured to store other scaling factors for determining the credit assigned to influencing events. In some embodiments, different factors may be applied depending on the type of advertising object 202 and the nature of the interaction constituting the influencing event. For example, it may be determined that a user clicking on a banner advertisement is more of an influence on the conversion event than an impression of a banner advertisement (i.e., the banner advertisement being displayed to the user). Therefore, in this example all influencing events that are clicks may be assigned a higher scaling factor than those that are impressions. Similarly, the location of the advertising object 202 may be a basis for applying a scaling factor. If it has been determined that advertising objects 202 encountered by a user 290 on Facebook^{SM}, MySpace^{SM}, and other social media websites are greater influences on conversion events than advertisements on other types of websites, these social media websites may be assigned a higher scaling factor.

In other embodiments of the systems and methods disclosed here, factors other than recency factors may additionally be applied to influencing events in order to modify the credit given to the influencing event for influencing the conversion event. For example, in some embodiments, the credit given to an influencing event may be determined with reference to the chronological position of the influencing event in relation to other influencing events. It may be determined that a particular type of influencing event is most influential after a certain number of occurrences of similar influencing events. For example, it may be determined that a user is most influenced by a sponsored search result on the third occurrence of the user viewing that sponsored search result. Therefore, it may be possible, for example, to configure the system 200 to assign a larger portion of credit to the third influencing event comprising a sponsored search result impression.

In other embodiments, it may be possible to credit influencing events differently according to a behavioral targeting model. For example, if the age, gender, or other attribute of the user can be determined, the system 200 may be configured to assign a different amount of credit to a particular influencing event depending on those attributes. For example, it may be determined that males of age 18-44 are more likely than any other gender/age profile to be influenced by sponsored search results. Therefore, influencing events identified with users fitting that profile may be assigned a higher credit value than users fitting other profiles.

In several embodiments, the conversion event database 260 is configured to acquire, format, and store information about at least one conversion event in a conversion event record 262. The conversion event database 260 may be provided information about conversion events from a sales processing or accounting system external to the system 200. A conversion event may be defined as any desirable interaction between a user and a marketer. For example, a conversion may be a user 290 purchasing an item from the marketer's website. As another example, a conversion may be a user 290 signing up for a marketer's mailing list.

Upon occurrence of a conversion event, various data can be collected about the user 290. For example, in addition to the typical information required to process the conversion itself (such as the user's name, address, email address, phone number, shipping address, etc.), the IP address of the user's computer 292 may be tracked. In some embodiments, the tracking cookie 294 stored on the user's computer 292 during the earlier influencing events may be accessed. This tracking cookie 294 may contain a unique identifier or user/customer identifier for the user 290. Other methods for identifying a user 290 are known in the art and may be employed. In several embodiments, it is not necessary to collect any personally-identifying information about the user 290. This may be desirable if privacy is a concern. In these embodiments, the tracking cookie 294 may be used to correlate the user 290 carrying out the conversion event with all of the previous interactions between the user 290 and the marketer without regard to the actual identity (e.g., name) of the user 290.

The conversion event record 262 is configured to store the date and time that the conversion occurred. In some embodiments, the conversion event record 262 may store information about the type of conversion event, as well as the value of the conversion event. For example, in situations where a conversion is defined as a sale, the value of the conversion may be the gross revenue, net revenue, or net profit derived by the marketer from the sale. In other embodiments, for example, where a conversion is defined as a user signing up for a mailing list, a value may be manually assigned to that type of conversion, or alternatively no value may be associated with the conversion and a default value may be used.

In several embodiments, the conversion event record 262 stores a unique identifier for each conversion event. As discussed above, this unique identifier may also be stored in influencing event records 224.

Referring still to FIG. 2B, in several embodiments, the event identification engine 230 identifies events that are likely to have influenced the conversion event. In several embodiments, this may involve referencing event criteria 212 stored in the criteria database 210 to identify what types of events may qualify as influencing events, as described above. In some embodiments, the event identification engine 230 may be configured to access or generate data stored outside of system 200 and format and import the data into the event identification engine 230 as an event record 222. For example, in some embodiments, the event identification engine 230 may connect to an external database (not indicated) and download data in a proprietary, text, delimited, or other data format. In other embodiments, the event identification engine 230 may be configured to request and/or receive a data feed to be provided by an external data source (not shown).

The event identification engine 230 may be configured to identify influencing events that were driven by the same user 290 who drove the conversion event. This may be accomplished by referencing the user-identifying information stored in the influencing event records 224 and conversion event record 262. In some embodiments, the event identification engine 230 may be triggered by the occurrence of a conversion event. In other embodiments, the event identification engine 230 may be executed periodically, for example, every hour, day, week, or multiple thereof.

Referring still to FIG. 2B, in several embodiments, the apportioning engine 240 is configured to identify the defined time interval 252 in which each influencing event occurred. This may be accomplished by calculating, for each influencing event, the amount of time by which the influencing event preceded the conversion event, as discussed above. The apportioning engine 240 can then determine which defined time interval 252 the influencing event occurred in, and access the appropriate recency factor 254 for that influencing event. In some embodiments, the recency factor 254 may be immediately applied to the credit stored in the influencing event record 224 and this modified credit may be stored in the record. In other embodiments, the recency factor 254 may be stored in the influencing event record 224 to be applied or referenced later.

In some embodiments, the apportioning engine 240 may apply other scaling factors to the credit given to influencing events, based on, for example, the nature of the the user's interaction with the marketer. In several embodiments, the apportioning engine 240 may apply the debit factor 256 to the credit given to the last influencing event, for example, by offsetting the recency factor 254 by an amount equal to the debit factor 256.

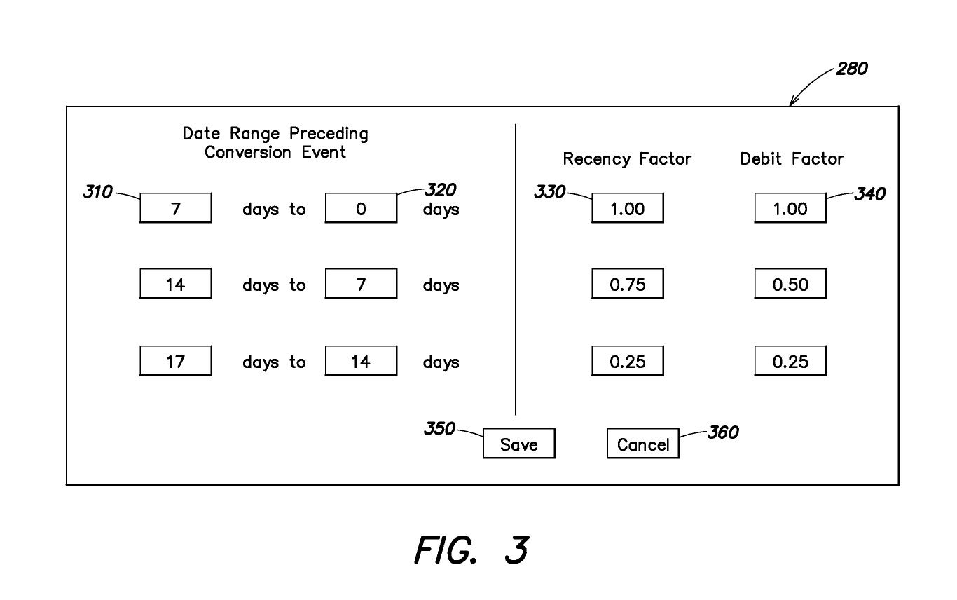

In several embodiments, a user interface 280 is provided such that a system operator 204 may interact with the components of the system 200 to perform system-related tasks, including but not limited to those described with reference to those described above. For example, in several embodiments, the system operator 204 may be provided an interface to define the defined time intervals 252 as described above. An exemplary user interface 280 is provided at FIG. 3. It will be appreciated that this user interface 280 is for illustrative purposes, and may contain additional areas for user input, as well as additional functionality omitted here for simplicity.

As seen in FIG. 3, the user interface 280 may contain boxes for the system operator 204 to input text or otherwise interact with the user interface 280. A start duration field 310 and an end duration field 320 may be provided to define the start duration and end duration, respectively, for a defined time interval 252. In this example, start duration field 310 has a value of 7 days and end duration field 320 has a value of 0 days, meaning that the defined time interval 252 provided in the top row of the user interface 280 covers the 7 day period from 7 days before the conversion event until 0 days before the conversion event (i.e., the day of the conversion event itself). A recency factor field 530 is provided to receive a recency factor 254 input from the system operator 204 for the same defined time interval 252. Similarly, a debit factor field 340 may is provided to receive a debit factor 256 input from the system operator 204 for the defined time interval 252. This debit factor may be used to offset the credit given to the final influencing event, as discussed above.

It will be appreciated that the user interface 280 may allow the system operator 204 to define any number of defined time intervals 252, or allow the system operator 204 to set the number of defined time intervals 252. The use of text input boxes is shown here for illustrative purposes only. It will be appreciated that any method of receiving input from a user may be used, including drop down box, slider, or other component. It will also be appreciated that the use of days as the unit of time here is for illustrative purposes. As described above, any unit of time may be used, and may be configurable by the system operator 204.

Input components may be provided to save or cancel the input choices made by the system operator 204. For example, a save button 350 may be provided to save the input, and a cancel button 360 may be provided to discard any changes made since the last save operation.

### Exemplary Methods

Having described various aspects of a system for attributing an online conversion to multiple influencers, the operation of such an attribution system is now described.

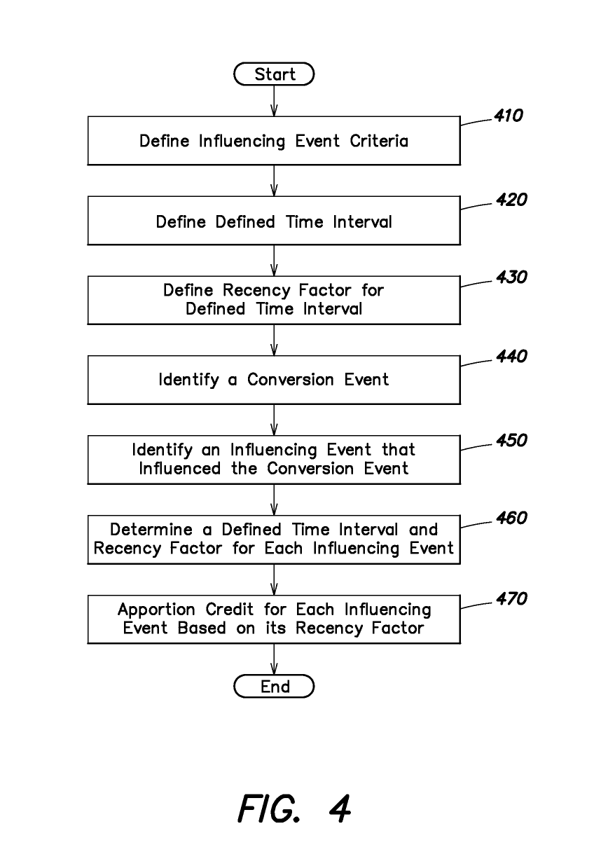

A method according to one embodiment of the invention is described with reference to FIG. 4. As shown in act 410 of FIG. 4, criteria are defined for at least one influencing event that influences a user to generate a conversion. The act of defining criteria may include identifying a type of advertising object and the nature of an interaction between a user and that advertising object, where this interaction is predicted to influence a later conversion. For example, the act of clicking on a banner advertisement may be defined as an influencing event. Such interactions are thus potential influencing events that the system will track and later correlate with a conversion event, if possible. In some embodiments, these criteria may be created, modified, and reviewed by a user of a computer system through use of an interface. In other embodiments, the criteria may already be defined, and may be enabled/disabled by a user, in other words, the user can instruct the system to track such events or not.

In act 420, a defined time interval is defined. A defined time interval is a period of time preceding a conversion event and defined by its temporal relation to the conversion event. For example, one defined time interval may cover the time period from 14 days before a conversion event through 7 days before the conversion event. In some embodiments, one or more defined time intervals may be created, modified, and reviewed by a user of a computer system through use of an interface. In these embodiments, the user may be provided the opportunity to define the start and end duration for each defined time interval. In other embodiments, the defined time intervals may be predefined.

In act 430, a recency factor is defined for at least one defined time interval. This recency factor will be used to scale the credit given to an influencing event occurring during the defined time interval. The recency factor may be a scalar quantity such as a decimal number, percentage, or other value representation. In some embodiments, the recency factor may be either a percentage or a decimal value less than 1, which is multiplied by the credit given to an influencing event occurring during the corresponding defined time interval. For example, a recency factor of 0.5 may be assigned, meaning that any credit given to an influencing event occurring during the defined time interval should be reduced by half.

In act 440, a conversion event is identified. For example, the system may be provided with relevant data each time a conversion occurs. This conversion data may be stored in a database, and may identify the date and time that the conversion occurred and any information identifying the user driving the conversion. In some embodiments, the conversion data may include any value associated with the conversion, if known, for example, the profit realized on the conversion.

In act 450, at least one influencing event is identified as influencing the conversion event. In some embodiments, a user is tracked for each interaction they engage in with a marketer. For example, a tracking cookie may be installed on the user's computer by a web browser or other executable software the first time the user interacts with the marketer. The tracking cookie may serve as a unique identifier of the user, such that it can be accessed and tracked during later interactions between the user and the marketer. When the same user is identified as later driving a conversion event, the previous interactions of the user can be identified. If those previous interactions meet the criteria defined in act 410, they may be flagged as influencing events.

In act 460, a defined time interval and associated recency factor are determined for each influencing event identified in act 450. In other words, each influencing event is fit into a defined time interval, if one exists for the time in which the influencing event occurred, and the recency factor associated with the defined time interval is associated with the influencing event. In some embodiments, a calculation is performed on each influencing event according to the amount of time by which it preceded the conversion event. For example, it may be determined that an influencing event occurred 9 days before the conversion event. Therefore, to continue the previous example, it can be determined that the influencing event occurred during the time period from 14 days before the conversion event through 7 days before the conversion event. The recency factor associated with that defined time interval can then be associated with the influencing event.

In act 470, credit for the conversion event is apportioned among the influencing events identified in act 450, according to the recency factor associated with each influencing event in act 460. In some embodiments, this act 470 includes multiplying the recency factor by a standard amount of credit (e.g., “1”, or, in some embodiments, the value of the conversion) initially shared by all influencing events. In this way, different weights can be assigned to the influencing events leading up to the conversion event. In some embodiments, the credit given to earlier influencing events is debited from the last influencing event so that the amount of credit given does not exceed that which would be given under a “last click” model. In other embodiments, the credit given to the earlier influencing events is given in addition to that given to the last influencing event.

It will be appreciated that act 470 may be performed at any time after a conversion event and at least one influencing event have been detected. It will further be appreciated that several of the acts in method 400 may be performed more than one time, and may be performed for testing or tuning purposes. In some embodiments, this testing or tuning may be carried out in a non-production or test environment. For example, in some embodiments, the defined time intervals and recency factors may be defined or redefined after a conversion event and at least one influencing event have been detected. This may allow a user to vary the recency factor applied against historical data for influencing events and rerun the apportioning process as many times as desired. The user may evaluate the credit assigned to individual influencing events or categories of influencing events, and modify the recency factor and/or defined time intervals to determine optimal values for each. In this manner, a user can see how credit will be apportioned to influencing events and optimize the system, rather than rely on guesswork or trial and error in arriving at defined time intervals and recency factors.

In some embodiments, the credit values generated during the method may be used in formulating recommendations for bids placed on internet advertising objects. In other embodiments, the credit values may be passed to bid recommendation systems for further analysis and bid generation. In still other embodiments, the credit values may be passed to multiple bid recommendation systems, which independently use the credit values to generate bid recommendations for bidding on advertising objects. The resultant bids and/or the performance of the advertising objects may then be used to evaluate the optimality of the defined time intervals and recency factors used in arriving at the credit values.

### Exemplary Data Representation

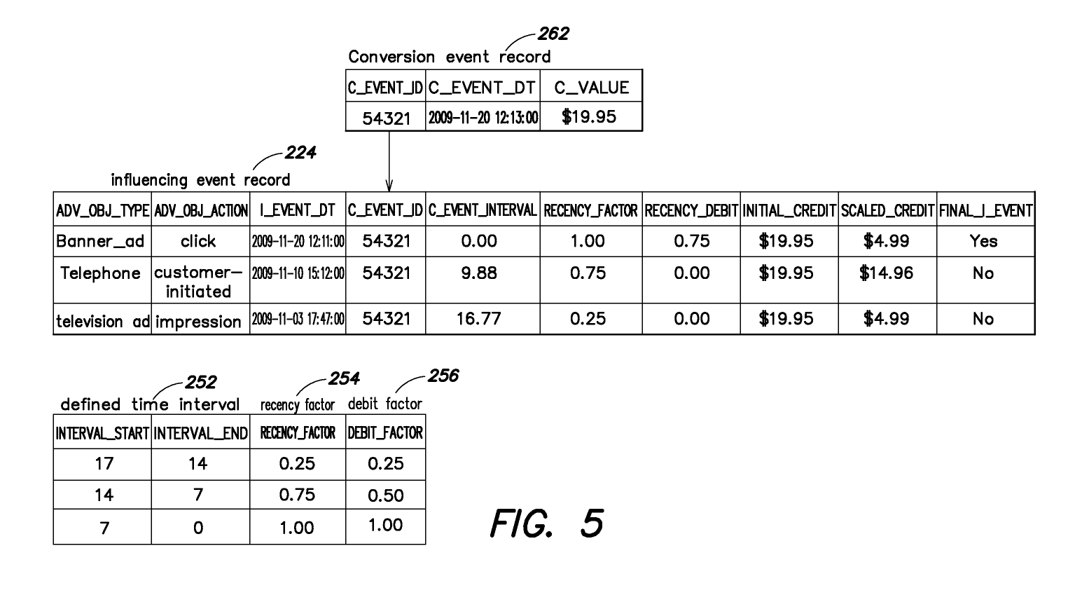

Example data formats for the conversion event record 262, the influencing event record 224, the defined time interval 252, the recency factor 254, and the debit factor 256 as they might be represented in a storage medium during and after execution of the method in FIG. 4 can be seen in FIG. 5. A conversion event has been detected and stored at conversion event record 262. The conversion event record 262 stores an identifier uniquely identifying the conversion event at C_EVENT_ID. The date and time at which the conversion event occurred is stored at C_EVENT_DT, and the value of the conversion (here, a profit of $19.95 earned on a sale) is stored at C_VALUE.

Three influencing event records 224 can be seen. These records store information about events identified after the conversion event to have influenced the conversion event. These influencing event records 224 may store information derived at the time of the influencing event. For example, the type of object and the user's interaction (for example, clicking on a banner advertisement or a customer-initiated telephone call to the marketer) are stored at ADV_OBJ_TYPE and ADV_OBJ_ACTION, respectively. The date and time at which the influencing events occurred are stored at I_EVENT_DT.

The influencing event records 224 also may have fields that are populated after the conversion event occurs. For example, the influencing event records 224 may also have a field C_EVENT_ID that operates as a key connecting the influencing event record 224 to the conversion event record 262 when the value stored in the two fields is identical. For example, here both influencing event records 224 have been updated to store a C_EVENT_ID indicating that the influencing event influenced the conversion event stored at conversion event record 262. Other fields may also be calculated. For example, by subtracting I_EVENT_DT from C_EVENT_DT, a C_EVENT_INTERVAL can be calculated representing the number of days between the influencing event and the conversion event. With reference to C_EVENT_INTERVAL, the proper defined time interval 252 and recency factor 254 can be identified, and the RECENCY_FACTOR field of the influencing event record 224 can be populated.

For example, for the first influencing event record 224, the influencing event occurred mere minutes before the conversion event. In fact, this influencing event record 224 has been flagged by setting the field FINAL_I_EVENT to show that it is the final influencing event. Additionally, a RECENCY_FACTOR of 1 is populated in the influencing event record 224, since the influencing event occurred during the defined time interval 252 having an INTERVAL_START of 7 days and an INTERVAL_END of 0 days, and that defined time interval has a RECENCY FACTOR of 1.

To continue the example, for the second influencing event record 224, the influencing event has a C_EVENT_INTERVAL of 16.77, meaning the influencing event occurred 16.77 days before the conversion event. Thus, a RECENCY_FACTOR of 0.25 is populated in the influencing event record 224, since the influencing event occurred during the defined time interval 252 having an INTERVAL_START of 17 days and an INTERVAL_END of 14 days, and that defined time interval has a RECENCY FACTOR of 0.25. In this embodiment, some of the credit given to earlier influencing events is debited from the last influencing event, and so the first influencing event record 224 is assigned a RECENCY_DEBIT of 0.50, since the other two influencing events each occurred during defined time intervals 252 having a DEBIT_FACTOR of 0.50. It should be noted that this is an example where the DEBIT_FACTOR need not be equal in magnitude to the RECENCY_FACTOR, since the RECENCY_FACTOR for the second defined time interval 252 is 0.75 but the DEBIT_FACTOR is only 0.50.

Since all three influencing events influenced the conversion event, they are assigned an INITIAL_CREDIT of $19.95 corresponding to the C_VALUE (the value of the entire conversion). The SCALED_CREDIT for each influencing event record 224 is then calculated based on the RECENCY_FACTOR and RECENCY_DEBIT fields. Here, the second influencing event record 224 (the telephone call) has been given 75% (0.75/1) of the credit. The third influencing event record 224 (the television ad impression) has been given 25% (0.25/1) of the credit. The RECENCY_FACTOR for the defined time interval 252 in which each of the two earlier influencing event occurred has been accessed and the total of these RECENCY_FACTORs is stored in the RECENCY_DEBIT field of the first influencing event record 224. Here, the total is 0.25+0.50=0.75. Subtracting the RECENCY_DEBIT from the RECENCY_FACTOR (1.00−0.75) leaves the the first influencing event record 224 with 25% (1−0.75/1) of the credit. These values are multiplied by the INITIAL_CREDIT to populate the SCALED_CREDIT values.

It should be appreciated that this data is presented for exemplary purposes only. In some embodiments, not all data fields shown will be present. In other embodiments, other data fields may be stored. In still other embodiments, relational database techniques may be used to eliminate the need for some data fields. For example, in some embodiments the INITIAL_CREDIT value is not stored for each influencing event record 224, and instead reference is made to the C_VALUE of the conversion event record 262 when calculating the SCALED_CREDIT of the influencing event record 224.

### Reporting Interface

In several embodiments, a system and method are provided for reporting the amount of credit apportioned to influencing events, through use of a reporting interface (e.g., in a computer-based interface), printed report, or provided to another system in a programmatic interface, such as an application programming interface (API). The system may provide for the user to select the amount of detail to be displayed through the reporting interface, such that the amount of credit apportioned to influencing events may be viewed by individual influencing events, or alternately may be summarized according to one or more factors.

For example, in some embodiments, the system may be configured to display the total amount of credit apportioned to all influencing events associated with a particular source or keyword. In other embodiments, the system may be configured to display the total amount of credit apportioned to all influencing events occurring during a particular time interval. For example, the system may display credit totals for all influencing events that occurred between 14 days and 7 days before their respective conversion events.

In other embodiments, the system may be configured to display other metrics, e.g., the total number of influencing events that are tracked during a particular time interval, a weighted total, and the number of conversions that were influenced by a given number influencing events.

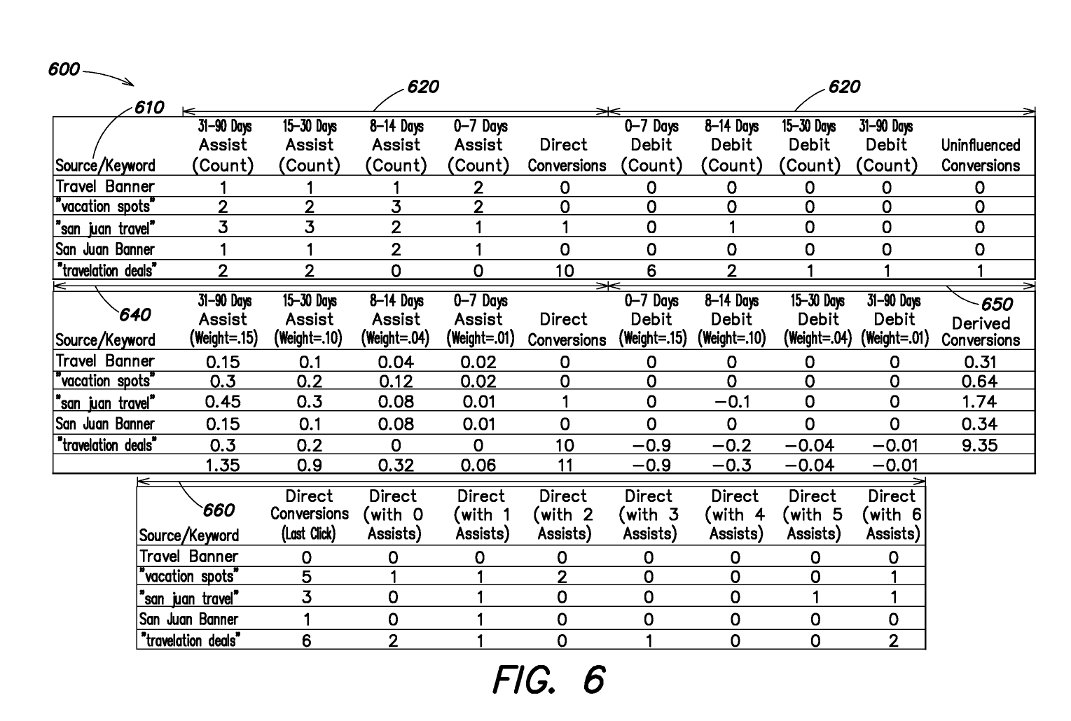

An exemplary reporting interface 600 can be seen at FIG. 6. The reporting interface 600 displays information about influencing events occurring during different time intervals, with the information summarized by the source or keyword associated with the influencing event. The source/keyword column 610 displays the source or keyword associated with the influencing event, for example, a keyword search for “san Juan travel.”

Referring still to FIG. 6, assist columns 620 display, for each source/keyword value, the total number of times the source/keyword was associated with an influencing event occurring during particular time intervals. For example, it can be seen that the keyword search “vacation spots” was an influencing event 3 times in the time period of between 14 days and 8 days before the conversion event(s) associated with those influencing events. Debit columns 630 display the total number of times that another influencing event was apportioned credit that otherwise would have gone to the influencing event associated with the given source/keyword. For example, it can be seen that credit from the keyword search “travelation deals” was apportioned 6 times to other influencing events occurring between 7 days and 0 days before the conversion event.

Referring still to FIG. 6, weighted assist columns 640 display values derived by multiplying the count values in the corresponding assist columns 620 by a “weight” value, i.e., a recency factor like those described above. Weighted debit columns 650 similarly display values derived by multiplying the count values in the corresponding debit columns 630 by a “weight” value. Direct conversion columns 660 display the number of times that a last influencing event (referred to in the interface as a “direct conversion”) was preceded by a particular number of other influencing events (or “assists”). For example, it can be seen from the first column of the direct conversion columns 660 that the keyword search “vacation spots” was a last influencing event 5 times. As can be seen in the other direct conversion columns, one of those influencing events was the only influencing event for the associated conversion event; one of those influencing events was preceded by one other influencing event; two of those influencing events were preceded by two other influencing events; and one of those influencing events was preceded by six or more other influencing events.

The reporting interface 600 is provided for exemplary purposes, and different configurations of data may be displayed and different statistical methods may be performed in other embodiments.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms. Furthermore, it will be appreciated that the systems and methods disclosed herein are not limited to any particular application or field, but will be applicable to any endeavor wherein a value is apportioned among several elements.

Where technical features in the drawings, detailed description or any claim are followed by references signs, the reference signs have been included for the sole purpose of increasing the intelligibility of the drawings, detailed description, and claims. Accordingly, neither the reference signs nor their absence are intended to have any limiting effect on the scope of any claim elements.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

What is claimed is:

1. A method for identifying and crediting interactions leading to a conversion event, comprising:
for each of at least one defined time interval, defining a recency factor used to scale a credit amount given to an influencing event occurring during the defined time interval;
identifying at least one influencing event that influenced a conversion event;
for each influencing event, identifying a defined time interval in which the influencing event occurred and accessing the recency factor for that defined time interval; and
apportioning the credit amount for the conversion event to the at least one influencing event according to the recency factor for each influencing event.

2. The method of claim 1, further comprising identifying the conversion event, wherein the act of identifying comprises processing information relating to the at least one influencing event.

3. The method of claim 1, further comprising defining criteria for the at least one influencing event that influences a conversion event.

4. The method of claim 1, further comprising:
assigning a first recency factor to a first influencing event; and
assigning a second recency factor to a second influencing event occurring after the first influencing event; wherein
the first recency factor is less than the second recency factor.

5. The method of claim 1, wherein the act of identifying a defined time interval in which the influencing event occurred includes:
for each of the at least one influencing event, calculating an elapsed time between the influencing event and the conversion event;
accessing an interval start time and an interval end time associated with the defined time interval; and
for each of the at least one influencing event, evaluating whether the elapsed time is less than the interval start time and greater than the interval end time.

6. The method of claim 1, wherein the act of apportioning credit for the conversion event among the at least one influencing event according to the recency factor for the influencing event includes multiplying a conversion credit by the recency factor.

7. The method of claim 1, further comprising, for each of the at least one defined time interval, defining a debit factor used to modify the credit given to an influencing event occurring during the defined time interval.

8. The method of claim 7, wherein credit apportioned to the at least one influencing event to according to the recency factor is debited from the credit apportioned to the influencing event occurring closest in time to the conversion event according to the debit factor.

9. The method of claim 1, further comprising the act of generating at least one bid recommendation for at least one advertising element associated with the at least one influencing event, wherein the bid recommendation is based on the credit apportioned to the at least one influencing event according to the recency factor associated with the influencing event.

10. The method of claim 1, further comprising the act of providing information about at least one advertising element to a bid recommendation system, the information including an identifier of at least one influencing event related to the at least one advertising element, the information further including the credit apportioned to the at least one influencing event according to the recency factor associated with the influencing event.

11. The method of claim 1, wherein the influencing event includes displaying an advertisement to a user of the world wide web.

12. The method of claim 11, wherein the advertisement is displayed in response to the user performing a search on a search engine web page.

13. The method of claim 11, wherein the influencing event further includes the user interacting with a hypertext link on an advertisement on the world wide web.

14. The method of claim 1, wherein the influencing event includes a user receiving an email.

15. The method of claim 14, wherein the influencing event further includes a user interacting with a hypertext link in an email.

16. The method of claim 1, wherein the influencing event includes a user dialing a telephone number selected from a plurality of telephone numbers, the selection being made responsive to an online search performed by the user.

17. The method of claim 1, wherein the influencing event includes a user dialing a telephone number displayed on a non-interactive medium.

18. The method of claim 1, further comprising the acts of:
for each of the at least one influencing events, accessing a second factor based on the nature of the influencing event;
associating the second factor with the influencing event; and
apportioning credit for the conversion event among the at least one influencing event according to the second factor for the influencing event.

19. The method of claim 18, wherein the second factor is an event type factor correlated to an attribute of the influencing event.

20. The method of claim 19, wherein a first event type factor is applied to a first type of influencing event, and wherein a second event type factor is applied to a second type of influencing event.

21. The method of claim 20, further comprising an act of:
for each of the at least one influencing events, multiplying the event type factor and the recency factor by the conversion credit to generate an adjusted conversion credit.

22. The method of claim 18, wherein the second factor is a user attribute factor associated with at least one attribute of a user associated with the influencing event.

23. The method of claim 22, wherein the user attribute factor is associated with the age of the user.

24. The method of claim 18, wherein the second factor is a chronological factor, and wherein the chronological factor is determined by a count of influencing events that occurred prior to the influencing event.

25. The method of claim 1, further comprising the act of receiving user input through a user to interface, wherein the act of defining criteria for at least one influencing event is performed in accordance with the user input.

26. The method of claim 1, further comprising the acts of:
receiving user input through a user interface; and
setting the recency factor in accordance with the user input.

27. The method of claim 1, further comprising the acts of:
receiving user input through a user interface; and
defining the defined time intervals in accordance with the user input.

28. A computer-readable medium comprising computer-executable instructions that, when executed on a processor of a server, perform a method for identifying and crediting interactions leading to a desired action, the method comprising acts of:
for each of at least one defined time interval, defining a recency factor used to scale a credit amount given to an influencing event occurring during the defined time interval;
identifying at least one influencing event that influenced a conversion event;
for each influencing event, identifying a defined time interval in which the influencing event occurred and accessing the recency factor for that defined time interval; and
apportioning the credit amount for the conversion event to the at least one influencing event according to the recency factor for each influencing event.

29. The computer-readable medium of claim 28, further comprising acts of:
assigning a first recency factor to a first influencing event; and
assigning a second recency factor to a second influencing event occurring after the first influencing event; wherein
the first recency factor is less than the second recency factor.

30. The computer-readable medium of claim 28, further comprising an act of, for each of the at least one defined time interval, defining a debit factor used to modify the credit given to an influencing event occurring during the defined time interval.

31. The computer-readable medium of claim 28, wherein the influencing event includes a to user dialing a telephone number selected from a plurality of telephone numbers, the selection being made responsive to an online search performed by the user.

32. The computer-readable medium of claim 28, wherein the influencing event includes a user dialing a telephone number displayed on a non-interactive medium.

33. The computer-readable medium of claim 28, further comprising the act of:
for each of the at least one influencing events, accessing a second factor based on the nature of the influencing event;
associating the second factor with the influencing event; and
apportioning credit for the conversion event among the at least one influencing event according to the second factor for the influencing event.

34. The computer-readable medium of claim 33, wherein the second factor is an event type factor correlated to an attribute of the influencing event.

35. The computer-readable medium of claim 34, further comprising an act of:
for each of the at least one influencing events, multiplying the event type factor and the recency factor by the conversion credit to generate an adjusted conversion credit.

36. The computer-readable medium of claim 33, wherein the second factor is a user attribute factor associated with at least one attribute of a user associated with the influencing event.

37. The computer-readable medium of claim 33, wherein the second factor is a chronological factor, and wherein the chronological factor is determined by a count of influencing events that occurred prior to the influencing event.

38. A system comprising:
an influencing event database configured to store information about at least one influencing event that influenced an online conversion; and
an apportioning engine configured to identify a defined time interval during which at least one influencing event occurred, and apportion credit for the online conversion among the at least one influencing event according to a scaling factor associated with the defined time interval.

39. The system of claim 38, further comprising a criteria database configured to store influencing event criteria.

40. The system of claim 38, further comprising a conversion event database configured to store information about at least one conversion event.

41. The system of claim 38, further comprising an identifying engine configured to identify an influencing event with reference to the influencing event criteria.

42. The system of claim 38, further comprising a factor database configured to store at least one scaling factor associated with at least one defined time intervals.

43. The system of claim 38, wherein the online conversion is a sale.

44. The system of claim 38, further comprising at least one interface configured to receive user input through a user interface, the user input including at least one scaling factor and at least one defined time interval.

45. The system of claim 38, further comprising at least one reporting interface configured to display information about at least one influencing event and at least one defined time interval.
